(19) United States
(12) Patent Application Publication
(10) Pub. No.: US 2008/0120180 A1
(43) Pub. Date: May 22, 2008

(54) Method for advertising in the internet

(76) Inventor: Kuo-Jen Tseng, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/600,918

(22) Filed: Nov. 17, 2006

(51) Int. Cl. G06Q 30/00

(52) U.S. Cl. 705/14

(57) ABSTRACT

A method for advertising in the Internet includes the steps of: providing storable content to be downloaded in a network server; displaying a main window on a screen of a network access machine for showing advertisement information therein when a network user begins to download the storable content from the network server on the Internet; displaying an interactive window, which is linked to the main window on the screen, for showing at least one request-action message therein during the download of the storable content; and permitting the download of the storable content to be progressed when the network user acts in response to the request-action message within a predetermined period of time.

### FIELD OF THE INVENTION

The present invention relates to a method for advertising on the Internet, and more particularly, to a method for advertising on the Internet wherein a network user is required to act in response to the advertisement on the screen in exchange for free but legal download of files from the network.

### BACKGROUND OF THE INVENTION

With the development of Internet technology, the population of netizens is on increase and publishing advertisements in the network becomes a promising business. The network advertisements often present in the form of an E-mail, a banner consisting of text and tables, and an images of the file type GIF or JPEG. Regardless of the forms, these network advertisements will not appear on the screen unless the network user has selected and clicked something else on the screen. Although there are network advertisements in a pop-up form which forces the network user to notice them, most Internet explorers have a certain function to prevent such advertisements from appearing. Therefore, it is difficult to know well the effects of the network advertisements if the advertisements cannot appear before netizens and last for longer period of time.

Now the Internet becomes a part of the human life. Any person can easily download files, such as those concerning music, movies, E-books, computer software and the like, from a network server on the Internet. It is often found that some unauthorized businessmen restore such files in their network server and provides a free download service for the public. This violates the intellectual property right of the originator.

Therefore, there is a need for an improved method for advertising on the Internet to overcome the shortcomings of the prior art.

### SUMMARY OF THE INVENTION

It is an object of the present invention to provide a method for advertising on the Internet wherein a network user is required to act in response to an interactive window which overlays a main window showing advertisement information on the screen when he/she begins to download storable content from a network server, to achieve effective delivery of advertisements.

Another object of the present invention is to provide a method for advertising on the Internet wherein a network user is required to pay attention and act in response to the advertisement on the screen in exchange for free but legal download of storable content from a network server.

To achieve the aforementioned objects, the present invention provides a method including the steps of providing storable content to be downloaded in a network server; displaying a main window on a screen of a network access machine for showing advertisement information therein when a network user begins to download the storable content from the network server on the Internet; displaying an interactive window, which is linked to the main window on the screen, for showing at least one request-action message therein during the download of storable content; and permitting the download of storable content to be progressed when the network user acts in response to the request-action message within a predetermined period of time.

As one aspect of the present invention, the storable content is selected from the group consisting of music, movies, games, text and images. The request-action message of the interactive window is displayed at irregular intervals and overlays at least part of the main window.

As another aspect of the present invention, the method includes a further step of discontinuing the course of download if the network user doesn't act in response to the request-action message within the predetermined period of time.

Other objects, advantages and novel features of this invention will become more apparent from the following detailed description when taken in conjunction with the accompanying drawings.

### BRIEF DESCRIPTION OF THE DRAWINGS

FIG. 1 is a flow chart of a method in accordance with the present invention; and

FIG. 2 is a flow chart illustrating how a network server is authorized to transfer storable content of a method according to the present invention.

### DETAILED DESCRIPTION OF THE PREFERRED EMBODIMENT

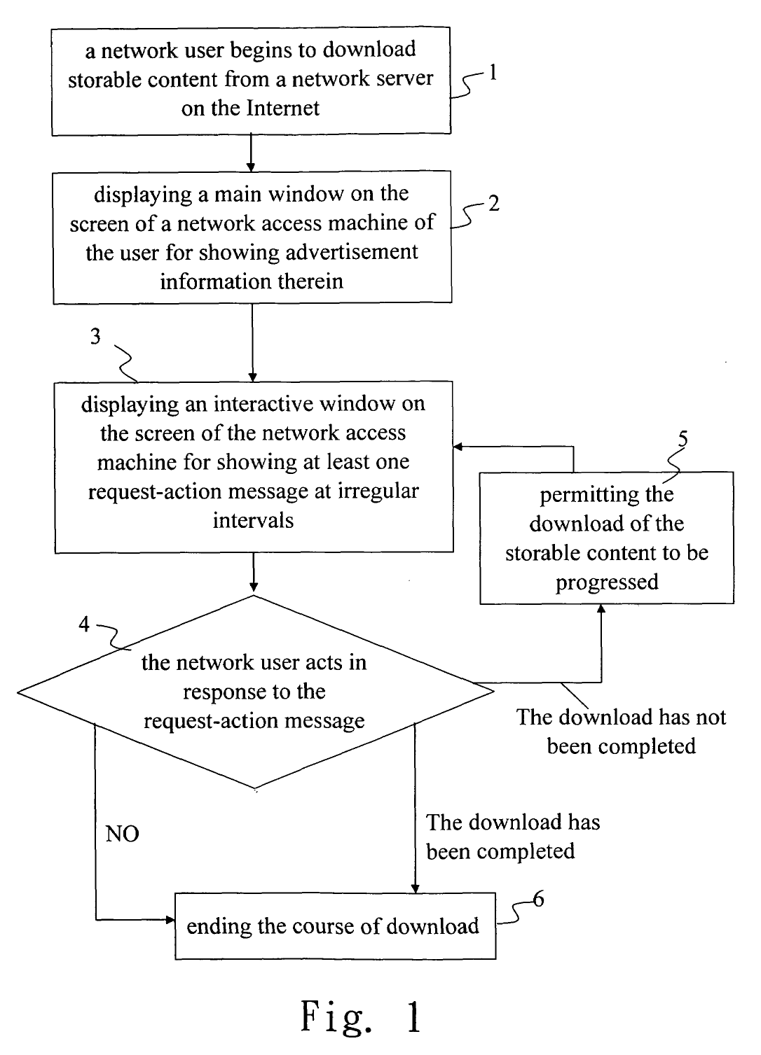

FIG. 1 depicts a flow chart of a method for advertising on the Internet in accordance with the present invention. As clearly shown, the method includes the following steps of:

1) a network user begins to download storable content from a network server on the Internet; 2) displaying a main window on the screen of a network access machine of the user for showing advertisement information therein; 3) displaying an interactive window on the screen of the network access machine for showing at least one request-action message at irregular intervals; 4) the network user acts in response to the request-action message; 5) permitting the download of the storable content to be progressed and repeating the step 3) through 5) until the download is accomplished; and 6) ending the course of download.

The inventive method can be applied to any Internet Service Provider (ISP), Internet Content Provider (ICP), Portal Site or those that provide download service.

The storable content can concern music, movies, games, text, images and the like, which, according to the present invention, a network user may download gratis from a network server on the Internet to a network access machine, such as a computer, a mobile digital device, an electronic household appliance or a communication apparatus.

As mentioned above, a main window showing advertisement information and an interactive window are displayed on the screen of the network access machine of the network user during the progress of the download. Preferably, both the main window and interactive window remain persistently visible on the screen to compel the network user to act in response to each request-action message until the download is completed.

More preferably, the interactive window contains a progress bar for the download in order to make the network user aware of the fact that the download is not completed and he/she must act in response to every request-action message to enable the download to progress.

In the step 3, the request-action message of the interactive window is displayed at irregular intervals, overlaying at least part of the main window. Preferably, each request-action message is a code produced by a code generator and the interactive window contains a text box for the network user to input or key the same code therein as the action which he/she is required to take in response to the request-action message.

In the step 5, the network server further discontinues the course of the download if the network user does not act in response to said request-action message within a predetermined period of time.

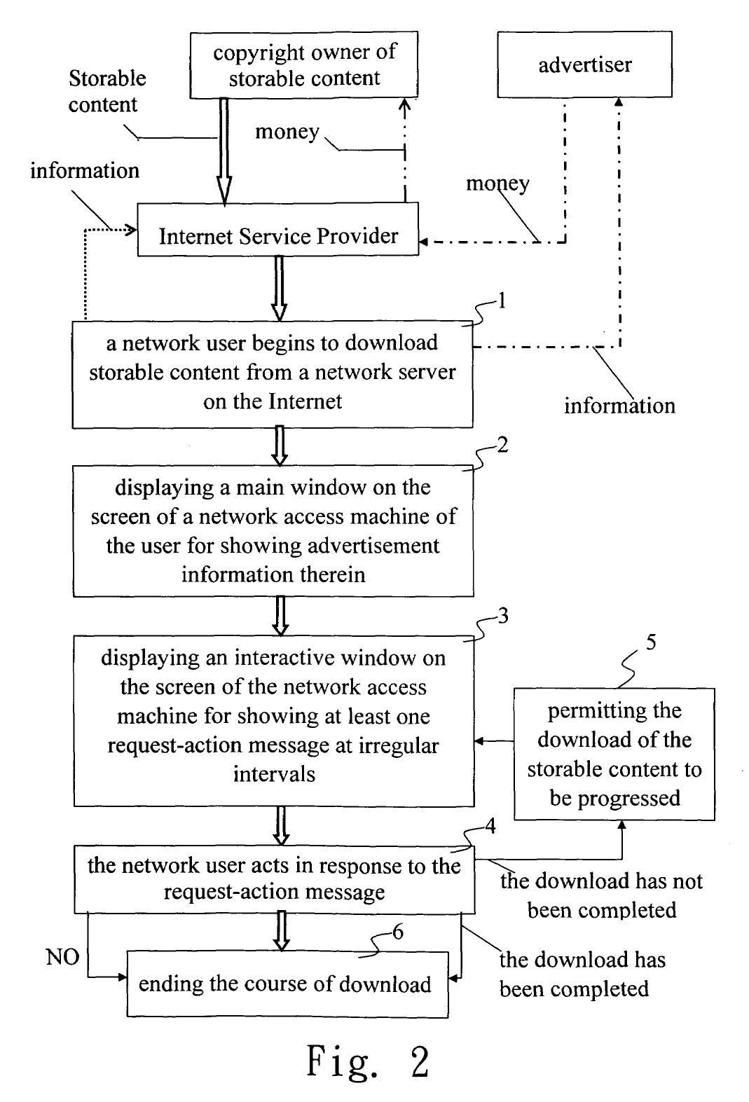

FIG. 2 depicts a flow chart of how an Internet Service Provider is authorized to transfer the storable content of a method of the present invention. From the time when the network user begins to download, the network server will send an information both to the advertiser and to the Internet Service Provider about the sum of the money which the advertiser should pay the Internet Service Provider, such as for the advertising and the downloaded storable content. The Internet Service Provider then pays the copyright owner of the storable content for its transfer. In this way, it is the advertiser who pays what the network user should pay for, and the network user gains storable content only at the expense of watching the network advertisement.

Instead of requiring the network user to input or key in the code, the request-action message of a more attractive, effective type may be any of the followings:
1. an animated image to be clicked on;
2. an amazing, interesting, interactive advergaming;
3. a simple amusing psychometrics; and
4. a market research, such as a questionnaire about a new product.

These different embodiments of the request-action message, which are illustrative but not restrictive, may entertain the network user watching the advertisement, thereby improving the effectiveness of the advertisement.

From the foregoing, it is apparent that the present invention is advantageous in that:
1. The inventive method may achieve good results in attracting a network user's attention to the advertisement and augmenting the efficiency of advertisements, because the user must act time to time in response to the change in the interactive window; and
2. The inventive method also allows free but legal download of storable content for a network user who expends time to watch the network advertisement, and so protects the intellectual property right of the originator of storable content.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A method for advertising on the Internet, comprising the steps of:
a) providing storable content to be downloaded in a network server;
b) displaying a main window on a screen of a network access machine for showing advertisement information therein when a network user begins to download the storable content from the network server on the Internet;
c) displaying an interactive window, which is linked to the main window on the screen, for showing at least one request-action message therein during the download of the storable content; and
d) permitting the download of the storable content to be progressed when the network user acts in response to the request-action message within a predetermined period of time.

2. The method as claimed in claim 1, wherein said storable content is selected from the group consisting of music, movies, games, text and images.

3. The method as claimed in claim 1, wherein said interactive window contains a progress bar for the download.

4. The method as claimed in claim 1, wherein said request-action message of the interactive window includes a code produced by a code generator, and a text box for said network user to input the same code therein.

5. The method as claimed in claim 1, wherein said request-action message of the interactive window is displayed at irregular intervals and overlays at least part of the main window.

6. The method as claimed in claim 5, wherein said request-action message of the interactive window includes a code produced by a code generator, and a text box for said network user to input the same code therein.

7. The method as claimed in claim 1 comprising a further step of discontinuing the course of download if said network user doesn't act in response to said request-action message within said predetermined period of time.

8. The method as claimed in claim 1, wherein said main window remains persistently visible in said screen of said network access machine.

9. The method as claimed in claim 1, wherein said network access machine is a computer, a mobile digital device, an electronic house appliance or a communication apparatus.
